(19) United States
(12) Patent Application Publication
(10) Pub. No.: US 2008/0086683 A1
(43) Pub. Date: Apr. 10, 2008

(54) Reporting engine for object relational networks

(76) Inventors: William Rich, Harrisburg, NC (US); Stephen Rickus, Mooresville, NC (US); Subramaniam Narayanasamy, Charlotte, NC (US); James Resio, Blacksburg, VA (US)

Correspondence Address: CLIFFORD CHANCE US LLP, 31 WEST 52ND STREET, NEW YORK, NY, 10019-6131, US

(21) Appl. No.: 11/906,618

(22) Filed: Oct. 3, 2007

Related U.S. Application Data
(60) Provisional application No. 60/849,926, filed on Oct. 6, 2006.

(51) Int. Cl. G06F 3/00

(52) U.S. Cl. 715/239

(57) ABSTRACT

A reporting engine for searching data in relational databases enables data retrieval through simple user input objects while respecting the business logic and security logic of the relational database. The reporting engine includes a template that expands user-input objects to search an exposed object network that is located in an application layer of the relational database. The reporting engine also displays the search results in output report format.

### RELATED APPLICATIONS

This application claims priority from U.S. Provisional Application Ser. No. 60/849,926 filed Oct. 6, 2006.

### BACKGROUND OF THE INVENTION

In relational databases, such as product lifecycle management (PLM) or product data management (PDM) systems, data is maintained in tabular form. Tabular form stores data in tables by types of data (e.g., phone number, addresses, login information) and links the data in different tables together. The linking (relations) between the data in the various tables is found through one or a number of relational “key” pieces of information in each table, such as a serial number or a login code. Relationships between tables are pre-set by logical rules and constraints.

To obtain data from relational databases, i.e., to generate a report that presents the data in user readable output, relational databases enable searches for target data. A user inputs a query into the relational database by entering search commands. A search language interprets the commands and retrieves the data. Once the data is retrieved it is transformed to report output format for the user's viewing.

An industry standard for obtaining data from relational databases is through use of Structured Query Language (SQL). SQL is designed for a specific, limited purpose—querying data contained in a relational database, and as such, it is a set-based, declarative computer language. SQL operates within and communicates with data servers of the relational database to retrieve the data.

Despite wide usage in the industry, SQL based searches present significant problems. For example, SQL, by directly accessing the databases' data server, bypasses system security and allows a user to access more than they may be authorized to view. For example, while SQL may block a user's viewing of entire tables, it does not block portions of a table when a user may only be authorized to view some but not all data in the table. Thus a user, in attempting to locate authorized information in one or a number of tables, could easily find restricted data that is located in the same tables.

Further, SQL bypasses relevant “business logic” of the database. While SQL works with relational databases in varied industries, each industry has unique attributes that results in different types of tables, keys and data models. Use of SQL requires the report-generating user to have detailed knowledge of the intricacies of the industries' systems data model and layout to know what to ask for. There is no advance synchronization of SQL terms with the business logic of the particular relational database.

Another method and system of generating reports from relational databases is through use of system coding. In system coding, a new method or function is coded in order to generate a desired report, wherein the code includes security concerns. This process, however, is very labor intensive and likely requires hundreds or even thousand of lines of code to generate the needed logic. This is highly expensive and typically requires a specialist. Further, system coding, like SQL, operates within the data servers of the relational database to retrieve the data and communicates directly with a data server of the relational database.

There remains a need in the art for a search engine that enables retrieval of data from a relational database that respects the databases' security and business logic while retaining simplicity of use.

### SUMMARY OF THE INVENTION

The invention provides a reporting engine that address the above stated needs by providing a reporting engine that uses application layer infrastructure, thereby having a report generating capability that is not labor intensive, respects the defined business logic, and obeys the application layer security.

According to an embodiment of the present invention, it includes a graphical user interface, a template containing processing instructions in a scripting language, the template selectable in the graphical user interface, the processing instruction enabling navigation of an application layer having exposing objects in an object network, and a transformation script operably associated with the template, the transformation script permitting transformation of found objects to a report output format.

According to another embodiment of the invention, it includes a graphical user interface, a template containing processing instructions in a scripting language, an application layer having exposed objects in an object network, wherein each object in the object network includes a type, and each Type includes a set of attribute values, the template operably associated with the application layer to search the object network in accordance with the processing instructions, and a transformation script operably associated with the template, the transformation script permitting transformation of found objects to a report output format.

According to another embodiment of the invention, it includes a method for searching a relational database and generating reports therefrom including the steps of selecting input objects on a user interface, identifying a template to use for processing, the template including a scripting language, expanding the template to an object network exposed by an application layer of the relational database, the object network composed of related objects, wherein the scripting language identifies requested objects by the objects Type or supertype, placing the requested objects in an intermediate structure format, transforming the intermediate structure format to a report output format, and respecting a security logic of the application layer such that only authorized objects are reported.

According to another embodiment of the invention, it includes method for searching a relational database and generating reports comprising the steps employing search criteria, navigating an application layer infrastructure of a relational database, the relational database spans multiple applications, searching external systems mapped into the relational database, and reporting on objects found in the application layer and external systems of the relational database based that meet the search criteria.

These and other features and advantages of the present invention may be realized by one of ordinary skill in the art by reference to the remaining portions of this specification, the drawings and the claims.

### BRIEF DESCRIPTION OF THE DRAWINGS

FIG. 1 is a block diagram showing general operation of the reporting engine.

FIG. 2 is a chart showing multiple ways to open a user interface from an operating system.

FIG. 3 is a template that comprises script language.

FIG. 4 is a chart showing expansion of the template to search objects in an object network.

FIG. 5 is an XML version of the search results.

FIG. 6 is a HTML version of a report output.

FIG. 7 is an XML version of the report output.

FIG. 8 is a diagram showing relationship navigation by the reporting engine.

FIG. 9 is a schema of the template expansion.

### DETAILED DESCRIPTION OF THE DRAWINGS

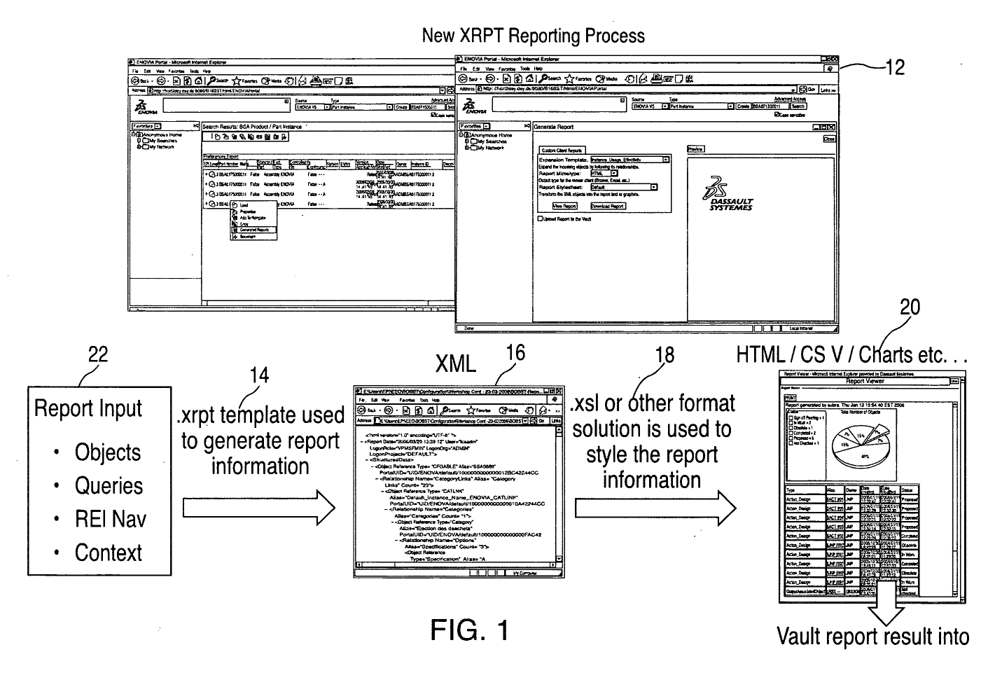

FIG. 1 shows one embodiment of a reporting engine that searches, processes and presents data from a relational database. In one embodiment of the invention, the relational database is a product lifecycle management (PLM) database or a product data management (PDM) database such as those manufactured by Dassualt Systems. Any database, however, that includes an application layer having a multiplicity of exposed objects in an object network, wherein the object network preferably includes database rows and database views, can be used with the reporting engine.

The reporting engine of the invention uses an application layer of the relational database such that it acts on/within the application layers that expose an object network. An object network is a multiplicity of objects in the application layer that can be interrelated. Each object in the object network has an object ‘Type’, wherein the object ‘Type’ is used for classification. The objects that are managed in the PLM space preferably have types that are common in Engineering/Manufacturing parlance, including but not limited to Parts, Documents, Tools, Materials, People, Projects, Groups, Organizations. In additional embodiments, objects may further have additional types. In further embodiments, the object preferably has a Supertype (a.k.a. Parent Type) that includes a multiplicity of types. In still other embodiments, types may also have an ancestor type, wherein the ancestor Type refers to any level above the type, including the parent type. Each type, in turn has a set of attributes, wherein the attributes describe the object as is known in the art. For example, a Part object, in situations wherein Parts refers to the objects that are used in manufacturing, may generally have the following attributes: an identifier, owner, status, creation timestamp, and priority. The attributes make it meaningful and usable in software and in the end to the user. In one embodiment, the object ‘Type’ is the name used to refer to the collection of ‘Attributes’ that are useful to describe any object of that ‘Type’, In this case, all objects of Type ‘Part’ would have common attributes (e.g. Weight, Color, Part Number, Version) which may be different than those attributes of ‘Document’ Type objects (Document Number, Version, Create Date, Modified Date). In a preferred embodiment, a typical generated report displays these attributes which could then be saved or printed.

The reporting engine navigates relationships between the objects and find objects that share certain types and/or attributes. Relationships link together objects in the database, for example, Users, Documents, Parts, Actions, et al. In one embodiment using an ENOVIA (Dassualt Systems) PLM object classification, relationship links keep track of which Parts make up a product (for example: Obj:Product→Rel:ChildParts→Obj:Part) or how a document is assembled from its files (for example: Obj:Document→Rel:Iterations→Obj:DocIteration→Rel:Formats→Obj:DocFormat→Rel:Attachment→Obj:DocFile). While these terms are substantially unique to the ENOVIA PLM object classification, all PLM software systems use similar terms to classify real life objects that are use in the Engineering/Manufacturing domain and are known in the art or are. The object and relationship Types are preferably not part of the reporting engine but are instead navigated by instructions that are described in .XRPT files. A creator of the XRPT files will understand the Type classifications that are used within a relevant company. In a real world analogy, an object can be a person and a relationship can be ‘cousins’, When this relationship is resolved by a reporting engine, cousins of the original person are found. In this example, the cousins relationship finds objects and processes and object network of the same type, i.e., people. Essentially, object networks can exist where virtually any one object is related to any other object as long as a certain commonality is explored. In a relational database such as a PLM, relationships are usually described and created by stand-alone applications. The reporting engine of the present invention leverages the application layer infrastructure of the relational database, which takes the object network described by stand-alone applications, and essentially navigates a super object-network that spans multiple applications. In cases where external systems are mapped into the relational database, the reporting engine can search the external system and report on their objects as well.

Leveraging by the reporting engine happens though processing one or a multiplicity of templates that the reporting engine is responsible for. The templates are user selected and describe expansion rules such as what objects and relationships to expand and report on. The reporting engine performs these expansions (i.e., gets objects and related objects) and outputs the relationship structure and attributes in a readable format such as XML format.

For each object, the reporting engine will look at the Type of each object and will thereafter look for a template to match for any objects on the object network. In certain embodiments, objects may inherit object types from each other. In this embodiment, some master object types, for example, ‘Action’, have subtypes like ‘Design Action’, ‘Signoff Action’, ‘Documentation Action’, or others. In this instance the reporting engine allows the definition <template match=“Action”> to apply to objects of all of those subtypes. Conversely, the definition <template match=“Signoff Action”> would not match any of the other subtypes, but only that one specific object type. In this embodiment the term ‘Action’ object is used to keep track of something that needs to be worked on and completed. In other PLM databases, this could be known as a ‘Task’ or like term. The template therefore functions with application layers that expose records in the databases as objects, wherein the objects preferably have associated types and supertypes and wherein relationships are created between and through objects of the same or different type.

A path of the reporting engine through the application layer preferably represents a tree structure that is, when one views it from top to bottom, similar to a tree only upside down. Shown in Example 1 is a simple structure. ‘Report’ 30 is a root element (analogous to a Root of the tree). ‘StructuredData’ 32 and ‘InstanceData’ 34 are child elements of the ‘report’ root element (analogous to the branches of tree.) ‘StructuredData’ 32 and the ‘InstanceData’ 34 are themselves sibling element to each other since they are at the same level. ‘ObjectReference’ 36 is a child element of ‘StructuredData’ 32 and is sometimes called a leaf object, since it does not have any child elements, but still has attributes. One attribute of ObjectReference 36 is ‘Type’ and value is ‘ECO’ 38. Both the StructureData and InstanceData elements are children of the Report element since they are contained between the open <Report> and close </Report> element tags.

### EXAMPLE 1

| <?xml version=“1.0” encoding=“UTF-8” ?> | |
|---|---|
| <Report> | (30) |
| <StructuredData> | (32) |
| <ObjectReference Type=“ECO” /> | (36) |
| </StructuredData> | (32) |
| <InstanceData Count=“1”> | (34) |
| <Object Type=“ECO”> | (38) |
| <Attribute ID=“ENOVIA_ECO.V_name” Alias=“CO ID”> | |
| GANTT-ECO | |
| </Attribute> | |
| </Object> | |
| </InstanceData> | |
| </Report> | (30) |

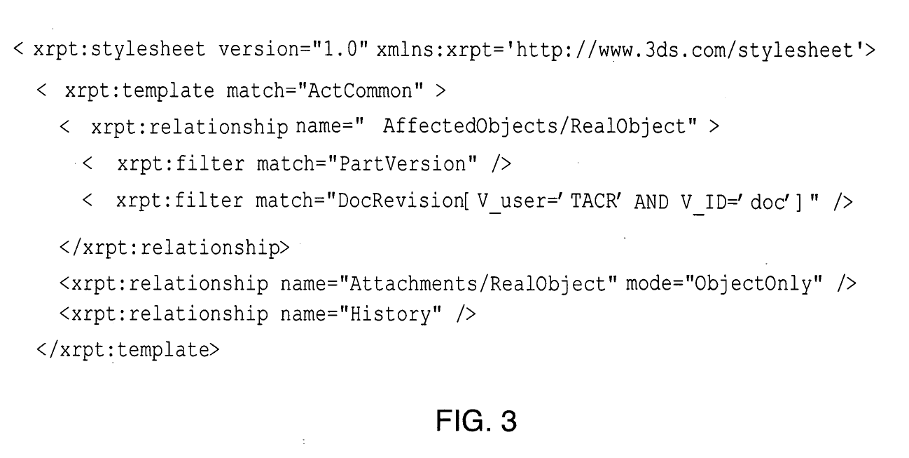

In the embodiment of the invention shown in FIG. 1, a user selects templates 22 and one or a multiplicity of objects on a user interface 12 in order to generate a desired report. Template 22, one embodiment of which is shown in FIG. 3, is a script language which is saved as a file having a new file extension to differentiate the Type of file from other types of files. Template 22 is not a free form script, but instead has rules. In a preferred embodiment, the format and rules are same as W3C standard. This makes the report expansion logic easier to define when compared to reporting functionality that requires C++/JAVA programming. While any unused file extension can be chosen to name the template file type, in a preferred embodiment of the invention, the new file extension is .xrpt. Templates may be set or may be customizable to any particular relational database. When building a custom template, the template is placed in a specific path in web server installation runtime (i.e., ./resources/report/templates) so that the application layer is enabled to pick up new definitions entered by the customization.

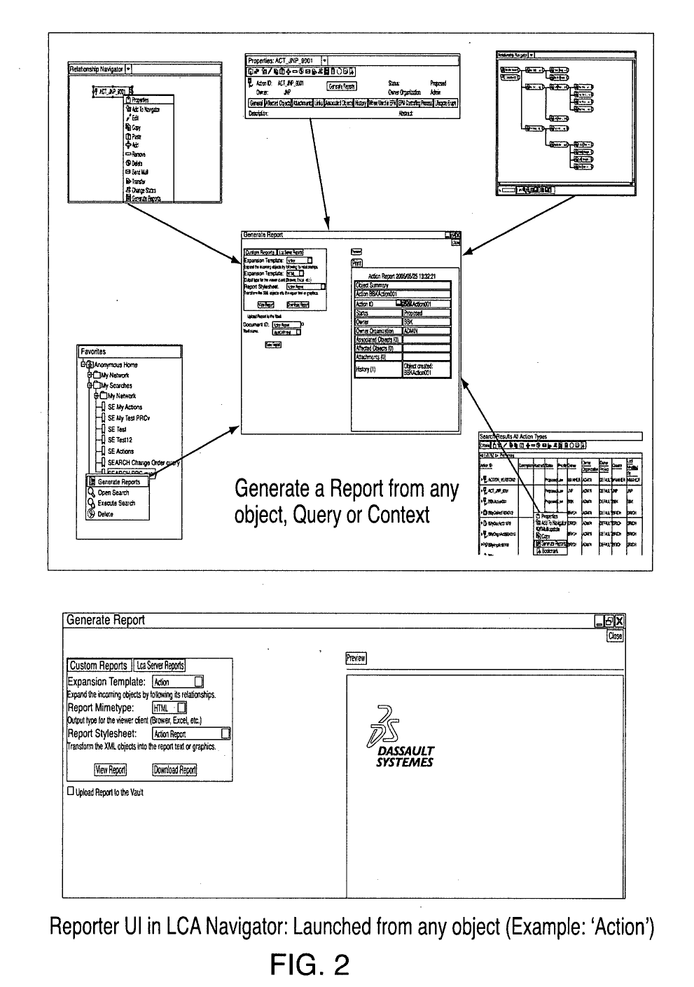

In preferred embodiments, user interface 12 can be launched by the user from a multiplicity of places in an operating system, as shown in FIG. 2. To generate the report, the user selects inputs in the user interface, selects a desired template, then actuates the search by clicking or typing a command in the user interface.

In one embodiment, if a user wants to get all parts used under a given object, for example, a Product at all levels in the tree, the user will select a template that can retrieve information for each usage of the part to get all Actions associated to the Product. In other words, a user can select a Product of interest and recursively expand it into its child component tree by selection and actuation of the template. (The creator of the template knows which Relationships are available for each input object type, and decides which need to be expanded in order to find all the information that is needed to fill out the content of the final report.) The user can then choose a template for this purpose, such as a “Configured Product” structure template, although the exact name of the template is immaterial. The user can then actuate the search by clicking ‘View Report’ or other like instruction. Once the objects and the template are selected by the user in the user interface, the reporting engine will execute the processing instructions contained in the template against each of the inputted objects.

Template 22 contains the processing instructions needed in order to generate the desired report. Templates are customizable, wherein the customization is typically done by an administrative user with familiarity with scripting language, although such customization is not limited in this respect. In practice, an XRPT customizable template author would preferably already know XSL syntax which is used in the XRPT files of the invention, as well as the object Type hierarchy of their own PLM database, and have some Domain knowledge to guide the author in expanding the right objects to summarize the information needed in the output report. In one embodiment, administrative users can specify object-Type filtering in the template. Alternate or additional attribute-based filtering is available in transformation to the record output. For example, it is possible to navigate on an action and get all the attached “Part” objects (as opposed to attached “Document” and other objects etc.,) in the template. The script language of the template uses syntax similar to standard xslt to reduce training to create new templates. The details of the XRPT structure and syntax is defined in a XSD schema file.

The scripting language provides a template creator with at least four key functional capabilities which allows the user to easily create a simple or complex report. For ease of use, the scripting language preferably uses substantially the same syntax as used in a standard xsl stylesheet, but contains its own unique name space (i.e. xrpt). These key functions are template, relationship, correlation, and filter.

The template is applied to a single object or a group of objects. In some embodiments, this means that the reporting template could be applied to a group of objects with different types. In order to verify that the desired reporting template is applied to the desired object types, the user has the ability to specify which objects a given portion of the script is available for, as shown in Example 2.

### EXAMPLE 2

### <xrpt:template match=“ActCommon”>

In this example, this portion of the script will only be applied to an object whose Type or ancestor Type is “ActCommon” (Common Action). This behavior otherwise works the same as it would in xsl. As it would be understood to one skilled in the art, the phrase ActCommon is used in some PLM databases and not other, and the user would use the appropriate Type search.

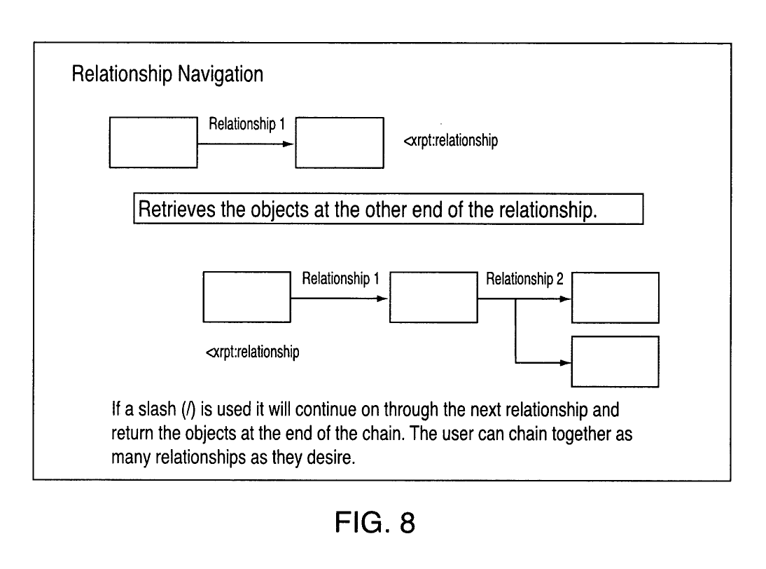

The relationship capability, as shown in FIG. 8, allows the user to navigate any of the relationships defined in the application layer. Relationships can be based on database navigation or coded business logic that produces any desired result. Relationships can be chained together in order to skip the intermediate results.

Correlation is useful in order to perform standard and inverse queries. For example, if a template user wanted to get an ID (key) of an object and use it to query for another object, the user would use correlation criteria. Two examples of correlation criteria are an AND function (returns true only if both criteria are true) and an OR function (returns true even if one criteria is true.) In both, for example, a query can be performed for all Organizations (i.e., Webtype=‘RscOrg’) whose V_ID matches the incoming Person object's (i.e., Webtype=‘RscPerson’) V_organization attribute. However, in example 3 below, both criteria are evaluated conditionally through an AND operation. In example 4 below, both criteria are added conditionally through an OR operation. These operations are implicitly specified and are dependent upon how the correlation criteria query is structured. The script preferably infers an AND when multiple criteria are in one correlation element. In this instance, the script preferably conveys the idea of one or more XML <criteria> elements inside one <correlation>elements to retrieve the objects that match both criteria. To support an OR case, two correlation elements are scripted with the same Name. In this instance, the script preferably conveys the idea of two separate <correlation> elements that have the same name=“xxx” value and retrieves the set of all objects that match any of the criteria.

### EXAMPLE 3

To form a query with an AND criteria:

```
<xrpt:template match=“RscPerson”>
  <xrpt:correlation name=“OrganizationInfo” type=“RscOrg”>
    <xrpt:criteria attr=“V_id”>{@V_organization}</xrpt:criteria>
    <xrpt:criteria attr=“V_name”>Test*</xrpt:criteria>
  </xrpt:correlation>
</xrpt:template>
```

### EXAMPLE 4

To perform a query with the criteria evaluated as an OR condition:

```
<xrpt:template match=“RscPerson”>
  <xrpt:correlation name=“OrganizationInfo” type=“RscOrg”>
    <xrpt:criteria attr=“V_id”>{@V_organization}</xrpt:criteria>
  </xrpt:correlation>
  <xrpt:correlation name=“OrganizationInfo” type=“RscOrg”>
    <xrpt:criteria attr=“V_name”>Test*</xrpt:criteria>
  </xrpt:correlation>
</xrpt:template>
```

The filter capability allows the user to filter the results of a navigation. If a navigation returns several types of objects, a filter can be applied so that only the desired objects are kept.

### EXAMPLE 5

### <xrpt:filter match=“PartVersion”/>

In this example the user will discard all other results and only keep PartVersion objects.

Turning back to FIG. 1, template 22 is then expanded 14 to navigate the application layer object network. The goal of the expansion is to gather all the information from the relational database that is necessary to create the final report. The template file drives expansion of user-selected input objects to related/correlated objects contained within the object network of the application layer. This is done through a series of navigations through the named relationships between objects and queries against other object types based on the current objects’ attribute values. This expansion of the template applies the selected (.xrpt) template file to the inputted objects. Thus, if the Product object of the above example does indeed include actual or computed relationships with other objects, the reporting engine will retrieve them and produce a report. If certain specified relationships are not available but other are available, the reporting engine will report whatever relationships are available. If none of the relationships are available, a report will be generated with just the Product attributes.

Further navigation is triggered by expanding the named relationship on the incoming object. In other words, the expansion processing is preferably recursive, in that the output of each step is used as the input to the next step. In this embodiment, the reporting engine is given one or more initial objects, which may match a template match=‘xxx’ selector, wherein match=‘xxx’ selector matches any object of Type ‘xxx’, i.e. ‘Part’, ‘Product’, or ‘Document’, Each object in turn is passed to its matching template. A body of this matching template describes which relationships to follow and what object type(s) to return. If any more objects are found when the expansion is finished, the process starts over with these new objects used as input to any matching template elements. In this way the process keeps unfolding the object/relationship tree until the leaf objects no longer match any template elements. Thus, the tree structure of the template are directives to get related objects, filter objects by Type or attribute value, or sub-query for similar objects.

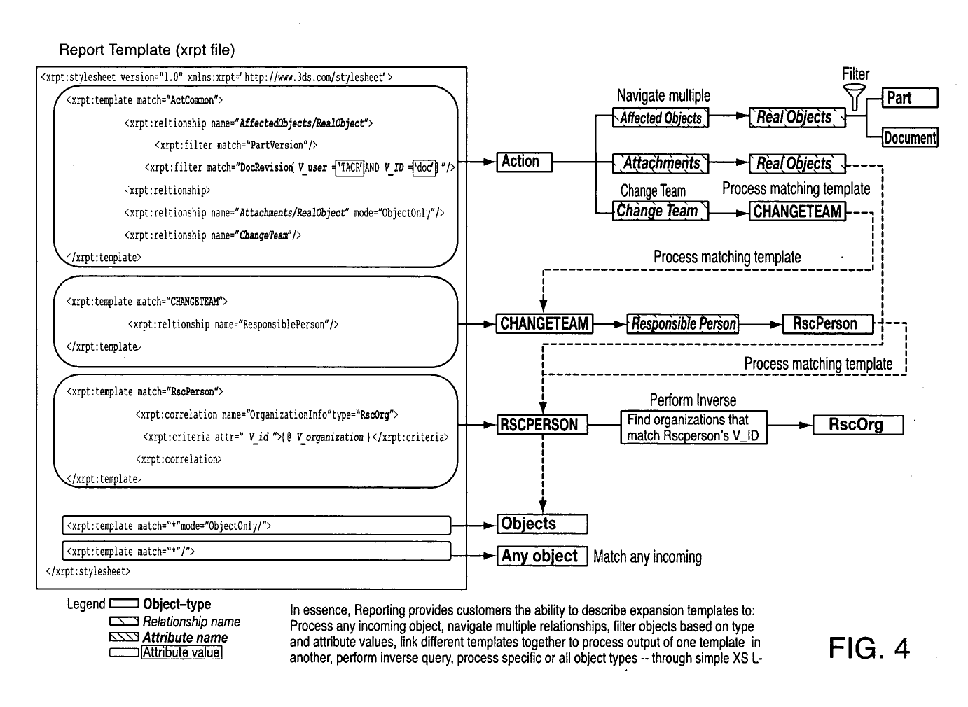

An example of expansion 14 is shown in FIG. 4. Terms in dark shaded boxes 40 refer to different classes of objects (i.e. action, document, rscperson), and terms in lightly shaded boxes 42 refer to relationships (i.e. changeteam, attachments) that have previously been defined in the relational database.

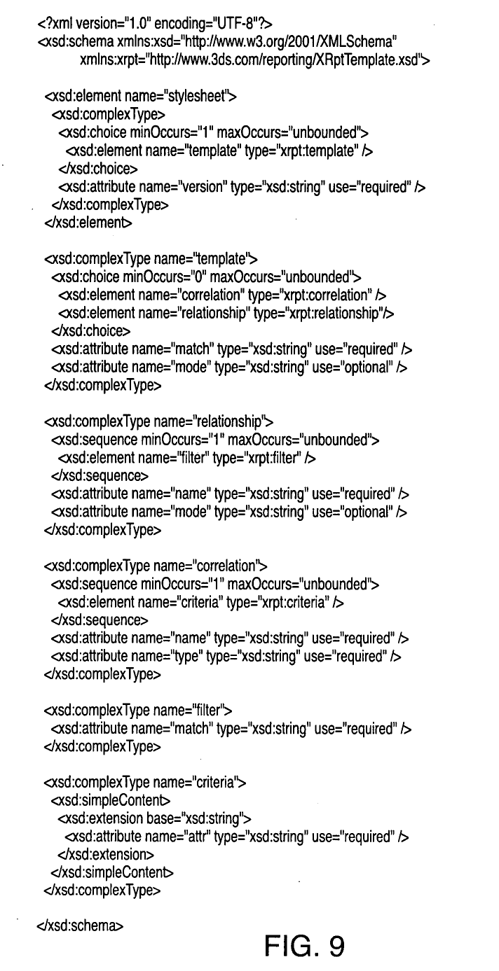

FIG. 9 shows a schema of the template expansion. The schema describes the format and rules of the template expansion. In the language of generally all XML files, including XRPT files, the structure and syntax of what is allowed is defined in a separate XML schema definition file (with a .xsd file extension). FIG. 9 is an XSD file that describes the format that XRPT files generally adhere to. For example, the XSD file defines that all XRPT files must have a 'stylesheet’ root element, with 1 or more ‘template’ elements as the first level children. Each ‘template’ element can contain 0 or more ‘relationship’ or ‘correlation’ elements only, and the ‘template’ element itself has a required ‘match= . . . ’ attribute and an optional ‘mode= . . . ’ attribute. This schema is used by tools to validate the template. The schema describes in a generic fashion how the template is structured.

The content of the desired report varies greatly depending on the industry and customer needs. By way of example, desired reports in manufacturing domains may report Product Structure or Bill of Materials (as-designed and as-built), Work Break-down, Assembly Cost rollup and so forth. These are examples of industry-specific terms that are already in use in the art.

The exposed object network preferably includes objects and relationships relating to business and security logic. Business logic generally refers to sets of behavior that are coded to work a way that a certain segment of an Industry runs their business. Business logic monitors data to make sure that information stays in synch, provides a logical mapping of the data into industry recognizable components, and manages how individual pieces of data are created/modified/deleted and who has access for read/write. The business logic includes security logic, wherein the security logic determines the authority the user has to view any particular data. Security logic includes at least two types: (1) whether a registered user has authority to view a particular row in a table, and (2) whether the registered user has authority to view some but not all of the columns in the table. As the application layer's object network includes business and security and logic, the reporting engine takes into consideration the business security and logic that is located in the application layer and does not present a user with more than the user is entitled to view.

As compared to system coding reporting efforts, a report in the present invention can be generated in about 30 lines of script wherein the same report in system coding requires almost 800 lines of C++ code. This reduction is through largely through use of applications layer's business logic at the highest level. The present invention does not have to string together lower level pieces of business logic. Significant savings are also created by reducing compiling times and the need for the user or administrator to be a proven developer or specialist.

Further, by respecting the business logic, the output reports reflect substantially the same information the users are used to seeing if they use an application on the application layer. This is much harder to achieve when using lower level api calls or database queries. Reusing high-level business logic also allows adjustment to respect customization. If a user creates custom metadata or commands, they automatically make it available to the reporting engine.

By respecting the business logic, the reporting engine also respects the security logic. This contrast data retrievers such as SQL that go directly to the data servers and bypass the security logic.

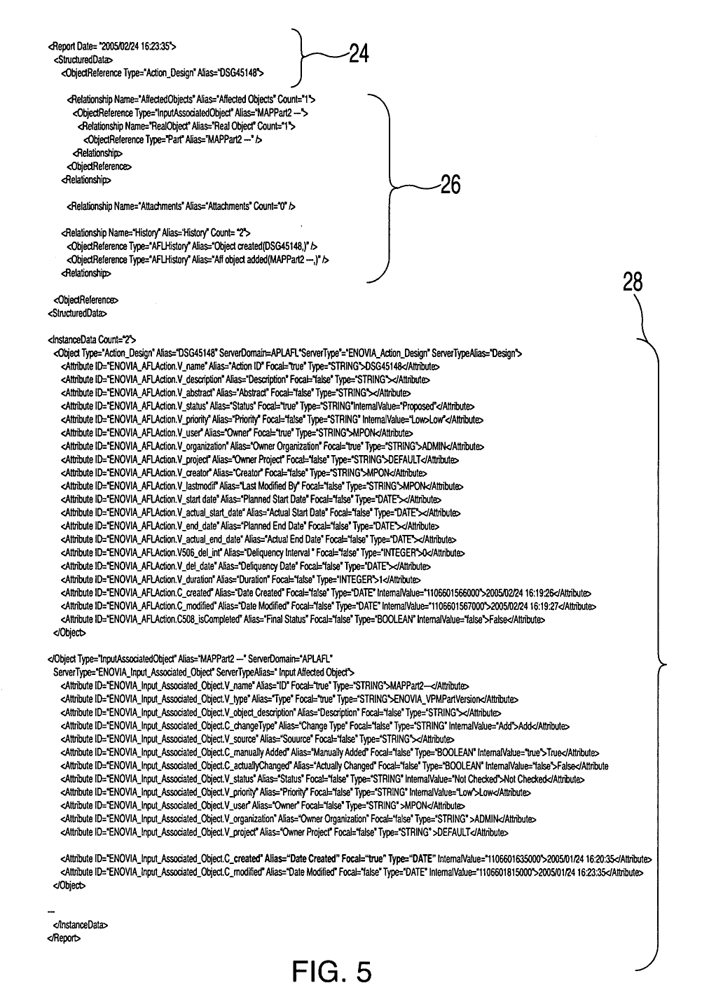

Again returning to FIG. 1, expansion 14 uses template and search language 22 to process objects from the application layer and thereafter place the processed objects in XML form 16. A sample XML form 16 is shown in FIG. 5. Structured data 24 shows the structure route elements that navigate the objects. Relationship names 26 provide the structure for structure data 24 and shows the relationships navigated by the template when searching the object network. Keys 28 show all objects encountered in the object network that fit the search language definitions.

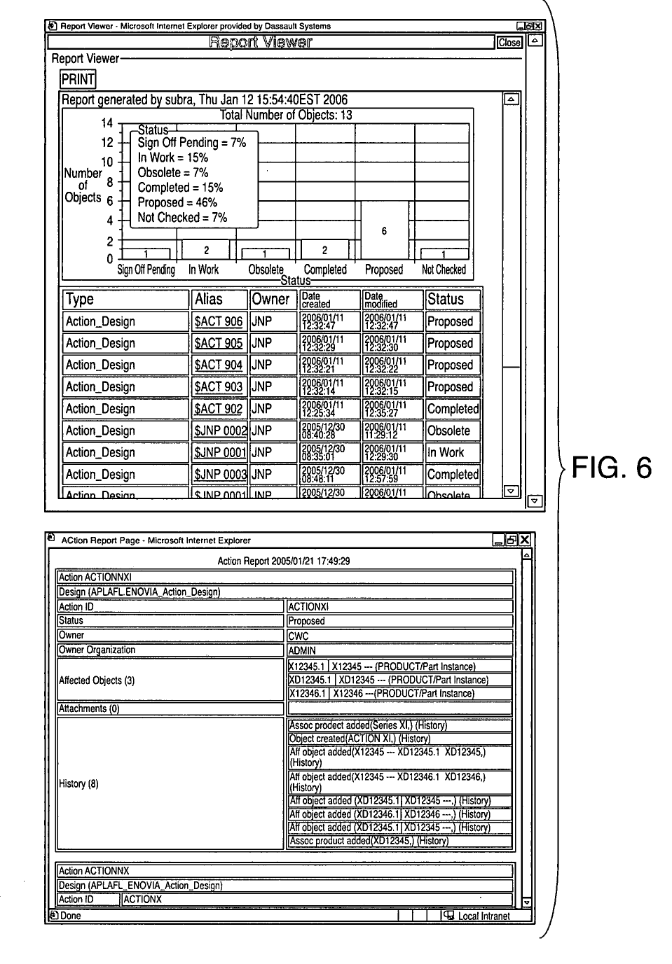

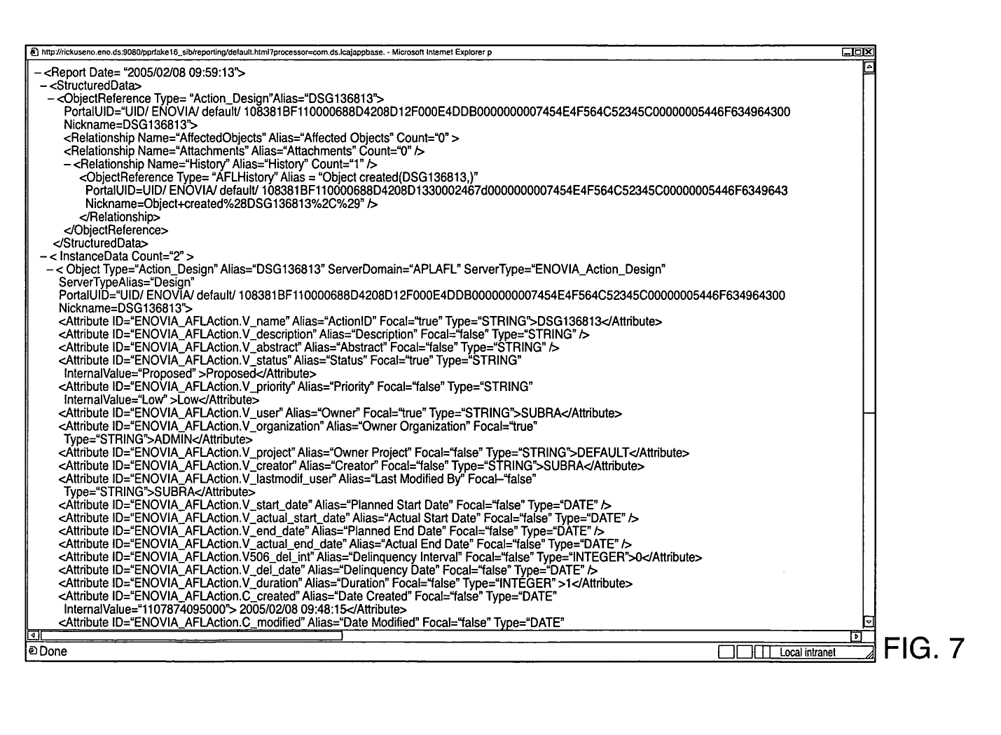

The XML is transformed into report output 20 by any transforming script known in the art such as xsl 18, as shown in FIG. 1. Report output 20 can be any format known in the art that is readable to one skilled in the art, such as HTML, XML, CSV, and TSV. FIG. 6 shows one embodiment of an html formatted output page. FIG. 7 shows one embodiment of an XML formatted output page. Due to the fact that the reporting engine operates in the application layer, the report output takes into consideration the user's login context and corresponding privilege and mask definitions to determine what data the user is authorized to view. Thus, assuming the user entered the database with their proper log-in or other identification information, report output 20 only displays objects and attributes the user is authorized to view. The report output further preferably includes the name and/or role of the person who generated the report along with a date and time stamp. The report can be sent to a printer or saved to a disk or file vault.

It will be appreciated that the present invention provides a reporting engine that uses the application layer infrastructure, thereby having a report generating capability that is not labor intensive, respects the defined business logic, and obeys the application-layer security.

A number of embodiments of the present invention have been described. Nevertheless, it will be understood that various modifications may be made without departing from the spirit and scope of the invention. For example, the reporting engine can be compiled into code with any one or a multiplicity of compilers known in the art. Accordingly, other embodiments are within the scope of the invention.

We claim:

1. A method for searching a relational database and generating reports comprising the steps of:
selecting input objects on a user interface,
identifying a template to use for processing, the template including a scripting language,
expanding the template to an object network exposed by an application layer of the relational database, the object network composed of related objects, wherein the scripting language identifies requested objects by the objects Type or supertype,
placing the requested objects in an intermediate structure format,
transforming the intermediate structure format to a report output format, and
respecting a security logic of the application layer such that only authorized objects are reported.

2. The method of claim 1, wherein the scripting language uses substantially the same syntax as xsl script.

3. The method of claim 1, wherein the template is customizable.

4. The method of claim 1, wherein the objects in the object network further include ancestor types.

5. The method of claim 1, wherein the intermediate structure format is XML.

6. The method of claim 1, wherein the intermediate structure format is converted in the transforming step with xsl.

7. The method of claim 1, wherein the scripting language searches one or a multiplicity of objects in the application layer.

8. The method of claim 1, wherein a Type of a first object is used to query a second object.

9. The method of claim 1, wherein one criteria of the scripting language searches is a filter criteria, wherein only certain types of objects are kept.

10. A method for searching a relational database and generating reports comprising the steps employing search criteria, navigating an application layer infrastructure of a relational database, the relational database spanning multiple applications, searching external systems mapped into the relational database, and reporting on objects found in the application layer and external systems of the relational database based that meet the search criteria.

11. The method of claim 10, wherein additional navigation is triggered by expanding a named relationship on a found object such that the output of a search is used as the input to a next search.

12. A reporting engine system comprising:
a graphical user interface,
a template containing processing instructions in a scripting language,
an application layer having exposing objects in an object network, wherein each object in the object network includes a type, and each Type includes a set of attribute values, the template operably associated with the application layer to search the object network in accordance with the processing instructions, and
a transformation script operably associated with the template, the transformation script permitting transformation of found objects to a report output format.

13. The system of claim 12, wherein the scripting language uses substantially the same syntax as used in a web server navigation of the relational database.

14. The system of claim 12, wherein the template is customizable.

15. The system of claim 12, wherein one or a multiplicity of types further include supertypes.

16. The system of claim 12, wherein the scripting language searches one or a multiplicity of objects in the object network of the application layer.

17. The system of claim 16, wherein a Type of a first object is used to query a second object.

18. A reporting engine system comprising:
a graphical user interface,
a template containing processing instructions in a scripting language, the template selectable in the graphical user interface, the processing instruction enabling navigation of an application layer having exposing objects in an object network to find objects, and
a transformation script operably associated with the template, the transformation script permitting transformation of found objects to a report output format.

19. The system of claim 18, wherein the scripting language searches one or a multiplicity of objects in the object network of the application layer.

20. The system of claim 19, wherein one criteria of the scripting language is based on correlation criteria, wherein a Type of a first object is used to query a second object.
